(19) United States
(12) Patent Application Publication
(10) Pub. No.: US 2011/0290922 A1
(43) Pub. Date: Dec. 1, 2011

(54) FIBER BASED MILLING DEVICE AND METHOD

(75) Inventors: Michael MELICK, Lebanon, OH (US); Lisa CLAPP, Cincinnati, OH (US); Paul MERCHAK, Loveland, OH (US); Russell SCHWARTZ, Cincinnati, OH (US)

(73) Assignee: Sun Chemical Corporation, Parsippany, NJ (US)

(21) Appl. No.: 13/117,074

(22) Filed: May 26, 2011

Related U.S. Application Data
(60) Provisional application No. 61/348,364, filed on May 26, 2010.
(60) Provisional application No. 61/439,150, filed on Feb. 3, 2011.

(51) Int. Cl. B02C 19/00

(52) U.S. Cl. 241/30; 241/220; 241/101.2

(57) ABSTRACT

The present invention describes a fiber based milling device for milling particles. The fiber based milling device includes a milling chamber with an inlet and an outlet, and also at least one fiber assembly. The fiber assembly contacts a particle to be milled in the milling chamber. Also disclosed is a method for milling particles by contacting the particles to be milled with a fiber assembly.

### CROSS REFERENCE TO RELATED APPLICATIONS

This application claims the benefit of U.S. Provisional Patent Application Nos. 61/348,364, filed on May 26, 2010, and 61/439,150, filed on Feb. 3, 2011. Both provisional patent applications are hereby incorporated by reference for all purposes as if fully set forth herein.

### BACKGROUND OF THE INVENTION

1. Field of the Invention

The present invention generally relates to a fiber based milling device, and a method of milling particles.

2. Discussion of the Related Art

Milling devices are useful in a wide variety of applications. In particular, milling devices are useful in the imaging industry to obtain particles with a reduced. For example, these properties are considered to be highly desired in pigments.

Milling typically involves repeated collisions of solid particles suspended in a slurry, or liquid dispersion, with a milling media. Generally, the milling media are spherical and are freely dispersed in a milling zone of a milling chamber. The repeated, random collision of particles to be milled with milling media by way of impact, shear and cavitation forces over a predetermined period of time causes the particles to break or de-aggregate. The fluid dispersion containing the particles is separated from the milling media by any conventional filtration step to recover the final product.

Milling devices employing conventional milling media have many drawbacks. For example, these milling devices require additional equipment in order to separate the milling media from the milled particles. Hence, the cost of the device is increased. There is a need in the art for a fiber based milling device that can easily be manufactured with fewer components, and is relatively low in cost. There is also a need for a fiber based milling device that can mill smaller particles.

### SUMMARY OF THE INVENTION

It is an object of the present invention to develop a fiber based milling device that is relatively easy to design and low in cost. Another object of the present invention is to develop a fiber based fiber based milling device capable of milling particles.

One advantage of the present invention may be a favorable, contact angle defined by the geometry of the fiber milling media employed in the fiber based milling device with respect to the particles to be milled.

Another advantage of the exemplary embodiment may include a simpler mechanical design for the fiber based milling device without filters to separate the final product from the fiber milling media.

According to the invention, these objects and advantages are obtained by the construction of a predetermined fiber assembly disposed in a milling chamber that produces a unique flow pattern causing high levels of shear and cavitation. In an exemplary embodiment, fiber(s) in a fiber assembly are fixed to an agitator shaft in a milling chamber.

In another exemplary embodiment, a fiber based fiber based milling device may include fiber(s) that are fixed to a component other than an agitator shaft in a milling chamber.

In a further exemplary embodiment a fiber based fiber based milling device may include at least some fiber(s) of a fiber assembly that are non-metallic.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

To achieve these and other advantages and in accordance with the purpose of the present invention, as embodied and broadly described, there includes a fiber based fiber based milling device comprising a chamber with an inlet and an outlet. The chamber includes a shaft and at least one fiber assembly. The fiber assembly may be secured to the shaft by a securing mechanism. Further, a motor may be connected to the shaft in order to provide power for rotating the shaft.

In another exemplary embodiment, a fiber based fiber based milling device may include a chamber with an inlet and an outlet. The chamber may include at least one fiber assembly and at least one securing mechanism. Further, the fiber based fiber based milling device may include at least one pumping mechanism.

In an additional, exemplary embodiment there is a fiber based fiber based milling device comprising a chamber having an inlet and an outlet. The chamber may also include a fiber assembly including one or more fibers. The chamber may also include a mechanism that moves one or both of the fiber assembly and particles to be milled in relation to one another. The fiber based fiber based milling device may also connected to a motor.

In another exemplary embodiment the fiber based fiber based milling device may include loose “cut” fibers in chamber that may be freely dispersed within a chamber in order to mill particles.

In a further, exemplary embodiment there includes a method of using a mill with fibers to mill particles. First, a quantity of particles to be milled are obtained. The quantity of obtained particles are fed into a milling chamber. A further step includes contacting said particles with a fiber assembly disposed in the chamber to reduce the size of the particles to produce milled particles. A further step includes removing the milled particles from the milling chamber.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1a illustrates a perspective view of a mesh enclosed configuration of a fiber mixing device.

FIG. 1b illustrates a mounting plate with holes as provided in FIG. 1a.

FIG. 2a illustrates a perspective view of a shaft collar configuration of a fiber milling device.

FIG. 2b illustrates a top view of the shaft collar configuration in FIG. 2a.

FIG. 2c illustrates another view of the fibers disposed in the shaft collar around the shaft as shown in FIG. 2a.

FIG. 3a illustrates a vertical fiber configuration fiber mixing device.

FIG. 3b is a detailed view of a perforated plate in FIG. 3a.

FIG. 3c is a detailed view of a fiber assembly located in a mesh screen in FIG. 3a.

FIG. 4a illustrates a horizontal fiber milling device.

FIG. 4b is a detailed view of a fiber brush assembly in FIG. 4a.

FIG. 5a illustrates a forced recirculation fiber milling device.

FIG. 5b is a front view of a fiber assembly along a shaft in FIG. 5a.

FIG. 5c is a side view of a shaft in FIG. 5a.

FIG. 6 illustrates a fixed fiber milling device.

FIG. 7 illustrates a photograph of a brush assembly.

FIG. 8 is illustrative of a method of the present invention.

### DETAILED DESCRIPTION OF THE ILLUSTRATED EMBODIMENTS

Reference will now be made in detail to exemplary embodiments of the present invention, examples of which are illustrated in the accompanying drawings.

An exemplary fiber based fiber based milling device is one capable of milling particles to a reduced size. The particles once milled by the fiber based milling device may be considered useful in product inks. In particular, the particles may be used to produce inks and toners and digital printing applications.

In addition, a fiber based fiber based milling device for producing such particles may be considered advantageous in other operations including, but not limited to, mixing, pre-mixing, blending and emulsifying. These particles may be solids, liquids, pastes, or combinations thereof.

An advantage of the exemplary fiber based milling device is the arrangement of one or more fiber assemblies having fiber or fibers located inside the chamber. This arrangement may produce a flow pattern which induces high levels of shear and cavitation. The high levels of shear and cavitation cause particles to be reduced in size to a size no less than conventional devices.

Another advantage of the fiber based milling device is the preferred contact between the fiber milling media and the particles to be milled. That is, the geometric size and shape of the fiber or fibers helps to break down the particles to be milled. It has been shown that the arrangement and geometry of the fibers inside the milling chamber significantly contributes to a preferred final product.

Another advantage of the exemplary fiber based milling device relates to the arrangement of fibers inside the milling chamber for reducing or eliminating the need for additional equipment which separates the final product from the milling media. By so doing, there are fewer operational concerns associated with separating a fiber milling media from a fluid dispersion containing particles. By contrast with conventional milling media, the fibers of the present invention are capable of being fixed inside the chamber. The means employed to fix the fibers inside the chamber may be adjusted in order to mill particles.

The fiber based milling device may include plural configurations and run in different modes. The device may be run in batch mode, single pass mode or re-circulating mode. The environment and operating conditions such as temperature, speed, pressure and flow rate of the fiber mill typically depends upon the materials to be milled and is not otherwise restricted.

There are many approaches to construct a fiber based fiber based milling device of the present invention. At least a few of these approaches will be discussed below in order to teach the advantages of using the fiber assembly in the fiber milling device.

In one exemplary embodiment, the fiber based fiber based milling device may include a milling zone defined as a milling chamber. Milling of particles typically occur within the chamber. The chamber may be made of any material which is capable of accommodating the particles to be milled. In an exemplary embodiment, the chamber may at least comprise stainless steel. The chamber may also be made of other materials, including but not limited to, a metal alloy, a ceramic, a polymeric blend, and polypropylene.

The fiber based fiber based milling device may also include a shaft. In a preferred embodiment, the shaft may be located anywhere with respect to the axial direction of the chamber. In a more preferred embodiment, the shaft may be centrally located with respect to the axial direction of the chamber. In another embodiment, there may be plural shafts in the chamber. Alternatively, the shaft may be located outside of the milling chamber

The shaft may be made of any material. Preferably, the shaft is made of stainless steel.

The shaft may be capable of rotating in a range from 50 to 12,000 rpm with a resultant fiber tip speed ranging between 300 to 8,000 feet/minute. The shaft may directly receive power from an electric motor. Alternatively, the shaft may indirectly receive power from an electric motor Preferably, the motor speed may be controlled by an autotransformer or a variable frequency drive.

The rotating shaft may be attached to one or more mixing blades. The blade may be a propeller, a ribbon blade, a Cowles® blade e or a D-blade. The mixing blade may be attached to a center shaft or a non-central shaft in the device. The mixing blade may also be located on a shaft outside of the chamber as discussed above.

In another exemplary embodiment, the fiber based fiber based milling device may include one or more fiber assemblies disposed within a chamber. Each of the fiber assemblies may include one or more fibers. The fiber or fibers may be made of a similar material. Alternatively, the fiber or fibers may be made from combinations of materials. For example, the fibers may be made of synthetic polymeric fibers, ceramic fibers, metal fibers and/or natural resin fibers.

An exemplary list of synthetic polymeric fibers may include polyolefins (e.g. polyethylene, polypropylene, high and ultra high molecular weight polyethylene and polypropylene); polyamide (e.g. nylon 6-6 and 6-12); aramid (e.g. Kevlar, Nomex, Twaron, etc.); polyester; polycarbonate; polystyrene; polyacrylic; polyphenylene; monofilament of nylon and other proprietary blends; and other polymeric materials or combinations of materials.

Polymeric fibers may also comprise core/shell polymers; surface treated polymers; and interpenetrating networks.

An exemplary list of metal fibers may include steel; aluminum; alloys, such as stainless steel 302, 304, 316, and other variants; brass; bronze; or other alloys containing copper, nickel, zinc, and other metals or a combination of metals. Metal fibers may also comprise surface treated metals; coated metals; and surface hardened metals.

An exemplary list of ceramic fibers may include, for example, metal oxides of aluminum, silicon, boron, or a combination of ceramics. Ceramic fibers may also comprise, but are not limited to, surface treated ceramics and surface hardened ceramics.

The natural fibers may include cellulosic types.

In an exemplary embodiment, the fibers may be formed in any shape, size or level of stiffness. The individual fibers may be comprised of a single type, or any combination of different types of shapes, sizes and/or stiffnesses. The fibers may be round. Alternatively, the fiber may be non-round. In an embodiment where the fibers are non-round, the fibers may include, but are not limited to, the following dimensions: oblong; 2-sided; 3 sided (e.g. triangular or tri-lobal); 4-sided (e.g. square, rectangular; rhombus; trapezoidal); star shaped (with 2, 3, 4, 5, 6 or more sides); 5 or more sided; and other polygon geometries.

In an exemplary embodiment, the fibers may be solid. Alternatively, the fibers may be hollow.

In another exemplary embodiment, the fibers may be conductive. Alternatively, the fibers may be non-conductive.

In another embodiment, the fibers may be linear. Alternatively, the fibers may be nonlinear. Examples of non-linear fibers includes curved, twisted or crimped fibers. In yet a further embodiment, the fibers may be both linear and non-linear.

In yet another embodiment, the fibers may be rigid. Alternatively, the fibers may be flexible. In a further embodiment, the fibers may be semi flexible. Configurations of the semi-flexible fibers include bent, looped, or multi-lobed.

For purposes of this disclosure, the fibers may have a uniform or non-uniform thickness. The thickness of the fibers may range from 0.5 to 10,000 microns. The fibers more preferably have a thickness from about 0.5 microns to about 2,000 microns. In an even more preferred embodiment, the thickness may be about 20 to 400 microns.

The fibers may be any length. The fiber length may be limited by the chamber in which they will be used. That is, the fibers may depend upon the scale of production. Fibers may fall into either of the major industry classifications of short “discontinuous fibers” or they can be cut from long “continuous” fibers. In an exemplary embodiment, the fibers may be longer than the dimensions of the chamber. This is possible in view of the flexibility of the fibers to bend and curve in order to contour to an inner wall of the chamber.

For purposes of this disclosure, combinations of different fiber types may be interspersed or separated in the fiber assembly. Groups of fibers may be comprised of high or low packing density. The fibers may also be comprised of a uniform or non-uniform packing density, or any combination thereof.

Further, the fiber assembly or assemblies containing one or more fibers may be patterned in any spatial orientation within the chamber. In one embodiment, the fiber or fibers may be perpendicular with respect to the shaft. Alternatively, the fiber or fibers may be disposed parallel to the shaft. The fiber or fibers may be disposed at virtually any angle relative to the shaft or at multiple or random angles. In another embodiment, the fibers are disposed at any angle relative to a plate located inside the chamber. The fiber or fibers may be regularly spaced. The fibers may be irregularly spaced. Fibers may be patterned in a spiral arrangement. Fibers may be patterned in a row. Fibers may be pattered in plural rows. Fibers may be longitudinally patterned. Fibers may be axially patterned. Fibers may irregularly be patterned whereby large fibers are followed by small fibers. Any combination of fibers may be used as a pattern suitable to contact the particles to be milled so as to reduce size of particles.

In another embodiment, the fiber based fiber based milling device may also include a securing mechanism. The securing mechanism may secure the one or more fiber assemblies to a predefined spatial location inside the chamber. In other words, the securing mechanism may help ensure that the fiber assemblies generally do not become freely dispersed within the chamber. By so doing, the fiber based milling device does not require additional equipment for separating the final product from the fibers.

The securing mechanism may include an enclosure. The enclosure may provide for a clearance between the fibers and an inner wall of the chamber. The enclosure may be detachable from the milling device. In another embodiment, the enclosure may not be detachable from the milling device. Some preferred examples of enclosures include, but are not limited to, cartridges, baskets and casings.

In one exemplary embodiment, the enclosure may be open. Alternatively, the enclosure may be non-open. The enclosure may be cylindrical. The enclosure may be non-cylindrical. Further, the enclosure may contain top, bottom and side walls.

In another embodiment, the enclosure may be porous for flow of a fluid dispersion into and out of the enclosure. For instance, the enclosure may include single or multiple pores. The pores may be round. Alternatively, the pores may be square. The pores may be rectangular. The pores may have non-uniform geometry. The pores may have uniform sizes. In a further embodiment, the pores may have a non-uniform size.

The porous enclosure may provide for a straight path for flow of a fluid dispersion. Alternatively, the porous enclosure may provide for a tortuous path for flow of a fluid dispersion. The porous enclosure may provide for a straight and tortuous path for flow of a fluid dispersion.

In yet a further exemplary embodiment, the enclosure may be comprised of a single material. Alternatively, the enclosure may be comprised of multiple materials. The enclosure may be comprised of, but not limited to, metals, polymers, ceramics. The enclosure may be comprised of coated surfaces or materials. The enclosure may be comprised of treated surfaces or materials. The enclosure may be comprised of hardened surfaces or materials.

The surface(s) of the enclosure may be smooth. Alternatively, the surfaces of the enclosure may be non-smooth in a uniform configuration. In yet a further embodiment, the surfaces of the enclosure may be non-smooth in a non-uniform configuration. Non smooth enclosures may include, but are not limited to, indentations; protrusions; grooves; baffles; pins; or combinations thereof.

In a further embodiment, the enclosure including the fiber assembly or assemblies may be secured directly to a shaft. Alternatively, the enclosure including a fiber assembly or assemblies may be indirectly secured to the shaft. For examples, the fiber assembly may be disposed on a disc or series of discs, which in turn, are secured to a rotating shaft. In addition, the fiber assembly may be disposed on one or more rods, bars, or plates attached to the rotating shaft.

In a further embodiment, the mesh screen may be directly fastened to an outer wall of the chamber. The enclosure may also be fastened to a plate at a bottom portion of the milling chamber.

In another exemplary embodiment, the fiber or fibers in one or more fiber assemblies may be fastened or anchored at any location on the fiber strand. Fibers may be looped such that both ends are anchored. Fibers may be anchored at their mid-point or some other point that is not the endpoint such that both ends of the fiber extend away from the anchor point. Fibers may be anchored or fixed at one or more locations in the device. Fibers may be anchored individually or in groups.

Alternatively, fibers may not be anchored at all. In other words, the fibers may be permitted to freely move within the milling chamber. The fibers may also be permitted to move throughout the fiber milling device. The separation of loose cut fibers from the particles to be milled in such an arrangement is still considered to be easier and less problematic than using conventional milling media. This may be attributed to the long strand-like geometry of the fibers versus conventional media. The long strand-like fibers are less likely to cause clogs in a milling chamber of the device.

In another embodiment, the milling chamber may be partially immersed in a fluid medium in a fluid medium chamber. The fluid medium vessel may be made of any material. The fluid medium vessel may be formed of any size to accommodate the fluid medium and a milling device. Alternatively, the milling chamber may be intermittently immersed in a fluid medium in a fluid medium vessel. In yet a further alternative, the fiber based milling device may not be immersed in a fluid medium in a fluid medium vessel.

The fluid medium is composed of the particles to be milled. The fluid medium may also comprise particles already milled that have been recirculated through the fiber based milling device which will be discussed in further detail below. The fluid medium may include a fluid such as water. Alternatively, the fluid medium may include a gas. Further, the fluid may alternatively contain any mixture of materials capable of transporting the particle to be milled through the milling device.

The fluid medium or dispersion may include solvents, pigments, resins, defoamers, surfactants and dispersants. These may include, but are not limited to, hydrocarbon resin varnish, alkyd varnish, magiesol 47 solvent, carbon black pigment, direct black 19 dye based colorant, high purity isopropyl alcohol, glycerin, deionized water, C.I. Pigment Yellow 14, urea crystal, ammonia, proxel GXL biocide, Surfynol DF110D defoamer and Joncryl 674 resin.

The fiber based fiber based milling device may also comprise a pump for moving the fluid medium into and out of the fiber based milling device. The fluid medium with the particles to be milled may be pumped into and/or out of the fiber based fiber based milling device as a metered or non-metered flow. The feeding of the medium into and/or out of the fiber based milling device may proceed at a restricted or non-restricted flow at virtually any rate that the fiber based milling device is equipped to handle.

The pump may form part of the fiber based milling device or alternatively be included in a system including the fiber milling device. The pump may be any standard pumping device. In particular, the pump may be a high pressure or peristaltic pump.

In a further embodiment, the fluid medium containing the particle is recirculated through the fiber based milling device. Many different methods and arrangements may be employed to recirculate the particle through the milling device. Recirculation may be conducted by continued agitation of the particles by an impeller located in the fluid medium chamber to propel the particle from the outlet of the fiber based milling device to an inlet of the milling device. Alternatively, recirculation may also be performed by pumping the particles through tubes that connect the inlet and the outlet of the fiber milling device.

In an exemplary, further embodiment, the fiber based milling device may include an automated system for detecting and controlling milling time. That is, the fiber based milling device may include a controller and a sensor. The sensor may be located anywhere in the fiber based milling device, or alternatively in a fluid medium chamber, for sensing whether a user-determined particle size has been obtained for the milled particles. If so, a controller stops operation of the fiber based milling device. If not, the controller continues to operate the fiber based milling device.

Reference will now be made in detail to embodiments of the present invention, examples of which are illustrated in the accompanying drawings.

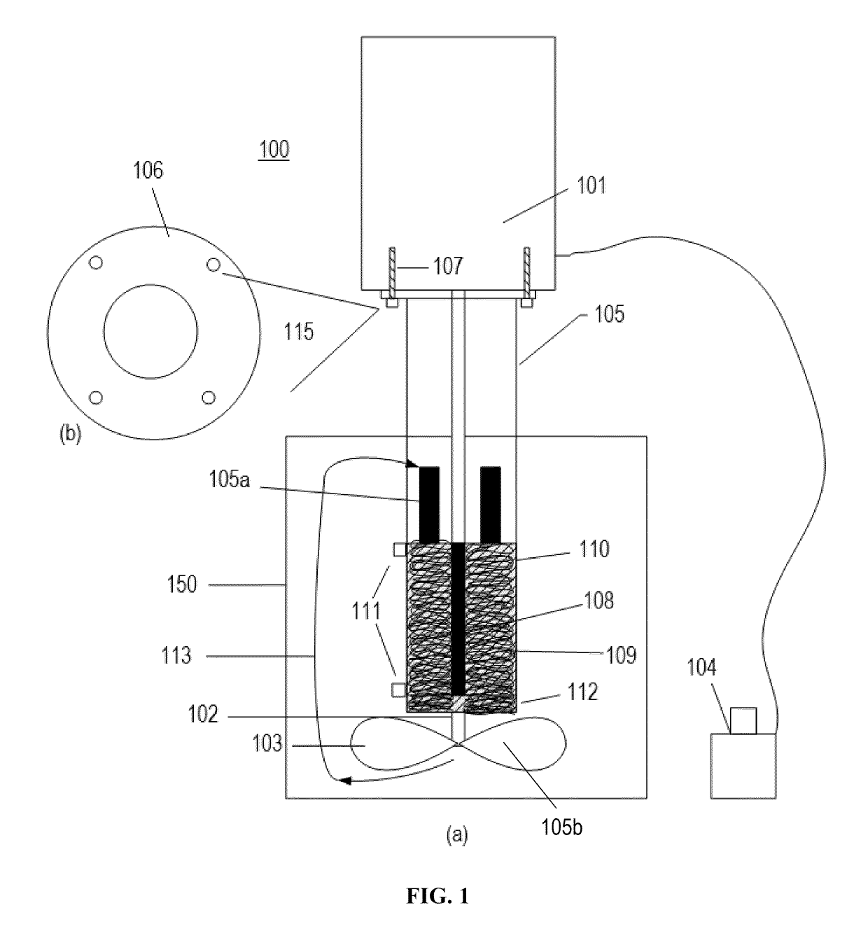

As shown in an exemplary embodiment of the present invention as illustrated in FIG. 1a, the fiber based fiber based milling device 100 may be partially immersed in a fluid medium vessel 150. The fluid medium vessel may also be referred to as a vat. The vessel may contain particles to be milled in a fluid. The fluid may be a liquid or gas. Preferably, the fluid is a liquid. The combination of the fluid and particle, being a slurry, may also be referred to as a fluid dispersion.

The fiber based milling device 100 includes a mixing head 101 (motor) attached to a shaft. 102. The shaft includes an impeller 103 that extends away from the mixing head. The mixing head 101 receives power from a power supply 104. The mixing head and power supply may be directly or indirectly connected to each other. By so doing, the shaft 102 and impeller 103 may rotate. Preferably, the impeller agitates a liquid dispersion containing a particle to be milled.

The mixer head may also be connected to a pipe 105 via a fastening mechanism. Any fastening mechanism may be used. Preferably long screws 107 may be used. In a preferred embodiment, a first end of a pipe 105 is welded to a plate 106 as shown in FIG. 1b. The plate 106 may be circular. The plate may include holes 115 extending from one surface of the plate to an opposite surface of the plate. The screws 107 may be used to connect the pipe 105 having a plate 106 welded thereon to the mixer head 101.

In a more preferred embodiment, the pipe includes an inlet 105a and an outlet 105b. The inlet may be formed as one or more slots along an outer wall of the pipe. The slots may be formed of any desired length so as to run along an axial direction of the chamber. By so doing, a liquid dispersion containing the particles to be milled, or intermediately milled particles, may recirculate through the chamber 105. Preferably, the impeller 103 agitates the liquid dispersion and facilitates movement of the liquid dispersion along a recirculation path 113 to the slots located in the pipe.

The chamber 105 contains at least a portion of the shaft 102. At least a first portion of the shaft is fitted with a substrate 108. The substrate may be a rubber matting or sleeve. In one embodiment, fastening mechanisms such as zipper type plastic ties are used to secure the substrate to the shaft. Any variation of the fastening mechanism may be used to secure the substrate to the shaft.

One or more fiber assemblies 109 may be disposed on the substrate. Preferably, the fiber assembly includes one or more fibers that are woven onto the substrate. The substrate may be one of the securing mechanisms for securing fibers to the shaft.

A mesh screen 110 may be disposed around the outer wall of the chamber. The mesh screen 110 may reduce the flow rate to therefore maintain the fluid in the fluid for a longer residence time. Upper and lower portions of the mesh screen may be fixed to an outer wall of the pipe by a fastening means 111. Preferably, the fastening means may be hose clamps. The bottom of the mesh screen may be supported by a ring 112. Preferably, the ring is made of stainless steel. One of the purposes of the mesh screen is to add a shear dynamic at the wall of the milling chamber 150.

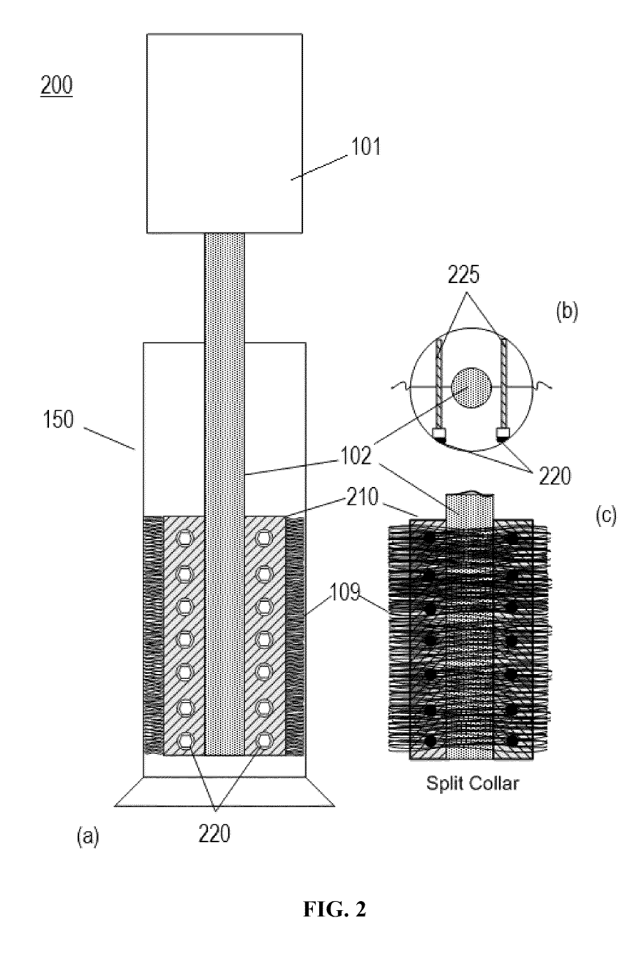

As illustrated in another exemplary embodiment of the present invention as shown in FIG. 2a, the mixing device 200 includes a mixing head 101, a pipe 105, a shaft 102 and a fiber assembly 109 as similarly illustrated in FIG. 1a. The fiber assembly is enclosed within a shaft collar 210. As depicted in FIG. 2a, the shaft collar 210 is made up of first and second portions along the axis of the shaft 102. The first and second portions may be equal halves. Alternatively, the first and second portions may be unequal halves. The first and second portions are capable of being joined to secure one or more fiber assemblies. In an exemplary embodiment, there are seven beveled points 220 capable of accommodating seven long screws 225. FIG. 2b illustrates the long screws connecting first and second portions around the shaft.

As shown in FIG. 2c, the two portions of the collar join to form an enclosure around the fiber assembly 109. Inside the shaft collar is placed a high density of fibers 109a of a fiber assembly 109. In a preferred embodiment, the fibers may be separated from an inner wall 105b of the milling chamber wall. The one or more fibers are held in place with a small amount of temporary adhesive while the two portions of the shaft collar 210 are rejoined. The collar may be configured so that a bottom of the shaft collar aligns with a bottom of the shaft.

As shown in FIG. 2a, the fiber based milling device 200 may be lowered into a fluid medium chamber 150. By so doing, the fiber based milling device is capable of milling a liquid dispersion containing a particle to be milled until.

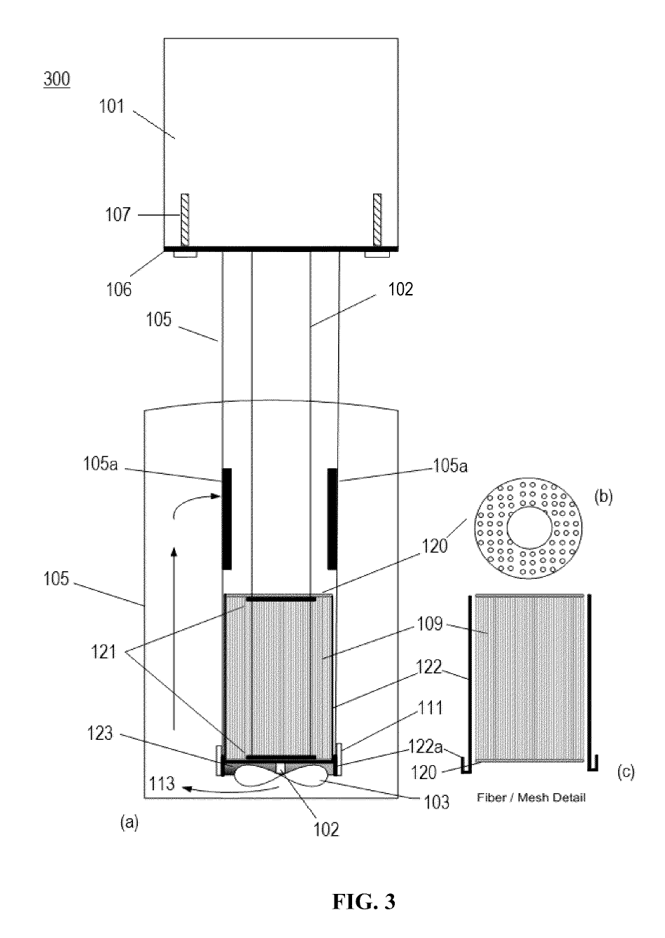

As shown in another exemplary embodiment of the present invention as illustrated in FIG. 3a, the mixing device 300 includes a mixer head 101, pipe 105, shaft 102 and impeller 103 as similarly referenced in FIG. 1a. The impeller 103 induces recirculation 113 of a particle in a liquid dispersion toward slots 105a in the pipe 105.

In an exemplary embodiment, fiber assembly 109 is fixed between two perforated plates 120 in the pipe 105. An illustration of the perforated plates can be found in FIG. 3b. In yet a further embodiment, the plates 120, with one upper and one lower, are perpendicularly configured with respect to an axial direction of the shaft. At least one snap ring 121 secures the fiber assembly and plate to the shaft 102. Preferably there are two snap rings. In still yet a further embodiment, the snap rings 121 are disposed between the perforated plates. That is, the snap rings may respectively be located below the upper plate and above the lower plate. By so doing, the fibers may remain immobilized in the axial direction of the shaft.

In addition, a mesh screen 122 is shown to enclose the fiber assembly. A detailed view of the mesh screen is provided in FIG. 3c. The mesh screen 122 includes a protruding bent portion 122a extending toward an inner wall 105b of said pipe 105. In a preferred embodiment, a predetermined gap exists between the fiber assembly 109 and the mesh screen 122.

The bottom of the mesh screen may be supported by a ring 123 perpendicularly disposed with respect to the axial direction of the shaft 102. Preferably, the ring 123 is disposed at a distal end of the shaft in proximity to the impeller 103. The mesh screen 122 is secured to the ring 123 via at least one hose clamp 111 that compresses the bent portion of the mesh screen against the ring and a portion of the pipe/chamber. As illustrated, the fibers 109 may be spaced apart from an inner wall of the mesh screen 122 by a predetermined distance.

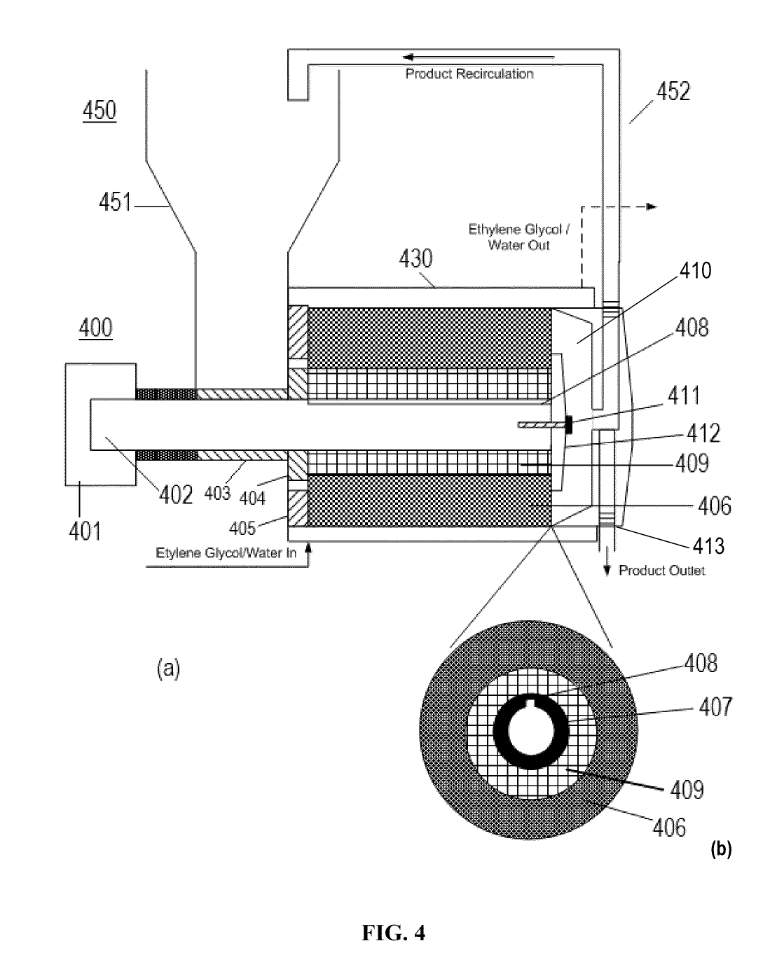

As shown in another exemplary embodiment of the present invention as shown in FIG. 4a, the fiber based milling device 400 is part of the recirculation assembly system 450. The recirculation assembly system 450 includes a hopper 451 and a recirculation line 452. The hopper may be formed of any shape. More preferably, the hopper is funnel-shaped to accommodate a slurry to flow through the hopper.

The fiber based milling device 400 may include a milling chamber 410 which further includes a rotating shaft 402 and a motor drive 401. Disposed at least around one section of the rotation shaft is a feed screw 403 through which particles in a fluid medium enter the device. The liquid dispersion travels through a gap formed between a pump impeller 404 and a feed ring 405 toward a fiber assembly 406 including one or more fibers. A shaft sleeve 407 along with a standard keyway 408 are formed around the shaft 402. The shaft sleeve 407 includes an inner and an outer diameter. A metal coil 409 is disposed around the shaft sleeve. Disposed around the metal coil are the fibers.

The chamber also includes a cooling jacket 410 to ensure that the temperature of the milled particles are maintained at an adequate temperature. In one embodiment, a mixture of ethylene glycol and water is supplied through the cooling jacket.

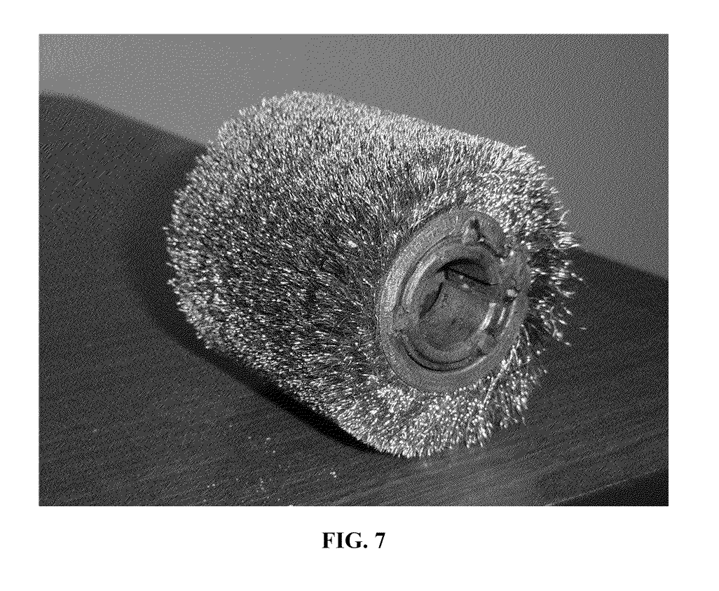

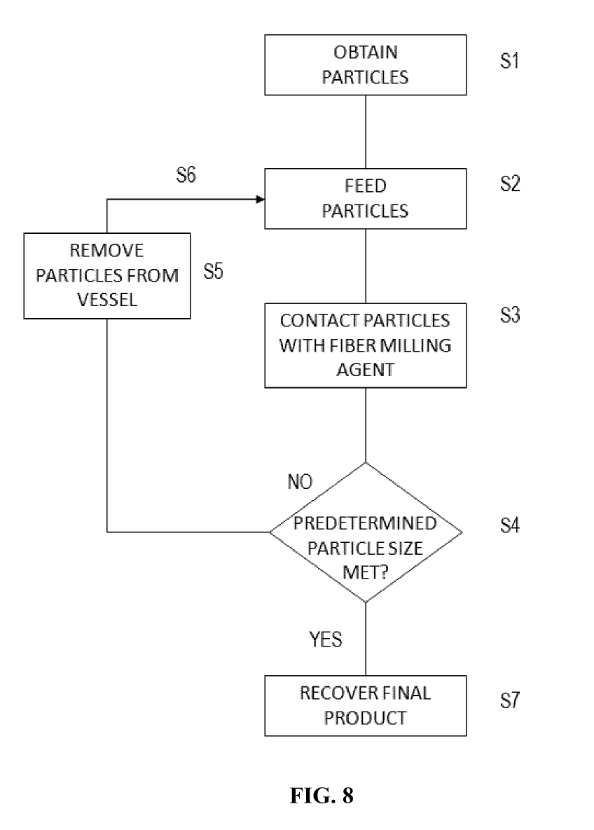

FIG. 4b preferably illustrates the different layers of the brush assembly. Specifically, the shaft sleeve and keyway may be surrounded by the metal coil. The metal coil may be surround by the fibers. The fibers are tightly woven into the coil and form a dense continuous fiber mat. In a preferred embodiment, the fiber mat is a brush assembly as shown in FIG. 7.

The spiral brush may be secured to the shaft via an end cap 412 and a screw 411 shown in FIG. 4a. There is also product outlet screw 413 in the milling device. Thus, milled particles may continue to recirculate through the assembly system. Once the final particle product has been obtained in the fiber milling device, product outlet screw 413 is opened and the final product is recovered.

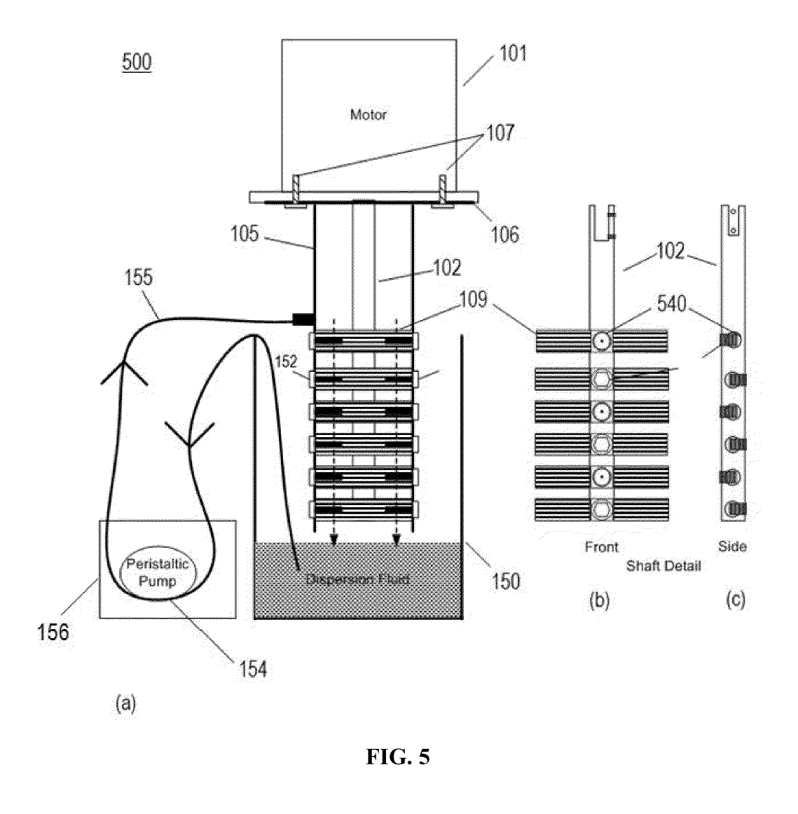

As shown in a subsequent exemplary embodiment of the present invention as illustrated in FIG. 5a, the fiber based milling device 500 may include a mixer head 101, a shaft 102, a power supply 104 (not shown), a pipe 105 welded with a plate 106, and a vessel 150 with a fluid dispersion located therein.

In this embodiment, the mixing device may be partially immersed in a dispersion. In an alternative embodiment, the mixing device may not be immersed in the dispersion containing the particles.

As shown in FIG. 5b, the shaft 102 may be machined with plural holes 540. The holes may be centered along a common axis of the shaft 102. Alternatively, the holes may irregularly be spaced along the shaft. Each hole may include a fiber assembly or bundle 109 disposed therein along an outer wall of the shaft. Each of the fiber assemblies may be capable of rotating with the shaft.

As shown in FIG. 5c, each fiber assembly may be secured in the hole by a screw 540. The arrangement of the fiber assemblies in the chamber 105 creates a unique flow pattern to enhance the contact between the particles to be milled and the fibers. In an exemplary embodiments, six evenly spaced holes 540 may be machined along the axial direction of the shaft 102. Each of the holes may include a fiber assembly secured thereto.

In yet a further exemplary embodiment, the length of each fiber assembly is selected so as to provide an excess length of fibers at an inner wall of the chamber wall 105. That is, the fibers may bend or curve when brought into contact with an interior wall of the pipe. This arrangement enhances high speed shear effects.

There are many different ways to further secure the fiber assembly 109 inside the chamber. For example, each of the fiber assemblies may include one or more screw insert sets 152 that are threaded into the pipe. Preferably each of the screws in a set may be threaded into the pipe at the same height in the axial direction of the chamber. The screw set may provide interference to the fiber bundles rotating around the shaft to prevent undesirable matting of the respective fiber bundles. In a preferred embodiment, each of the screw insert sets interferes with a fiber bundle at their midpoint along an axial direction of the chamber 105. In a more preferred embodiment, the pipe includes six machined holes, each hole being coincident with a fiber assembly 109 that is secured by a screw 540 and interfered by a screw insert set 152.

In a further embodiment, a pumping system may be used in combination with the fiber based milling device 500 to force recirculation of the particles. As illustrated, a peristaltic pump 154 is connected to a tube. Preferably, one end of the tube is connected to a slot located above the fiber assemblies for introducing or reintroducing particles disposed in a fluid dispersion. Another end of the tube is disposed in the fluid medium chamber.

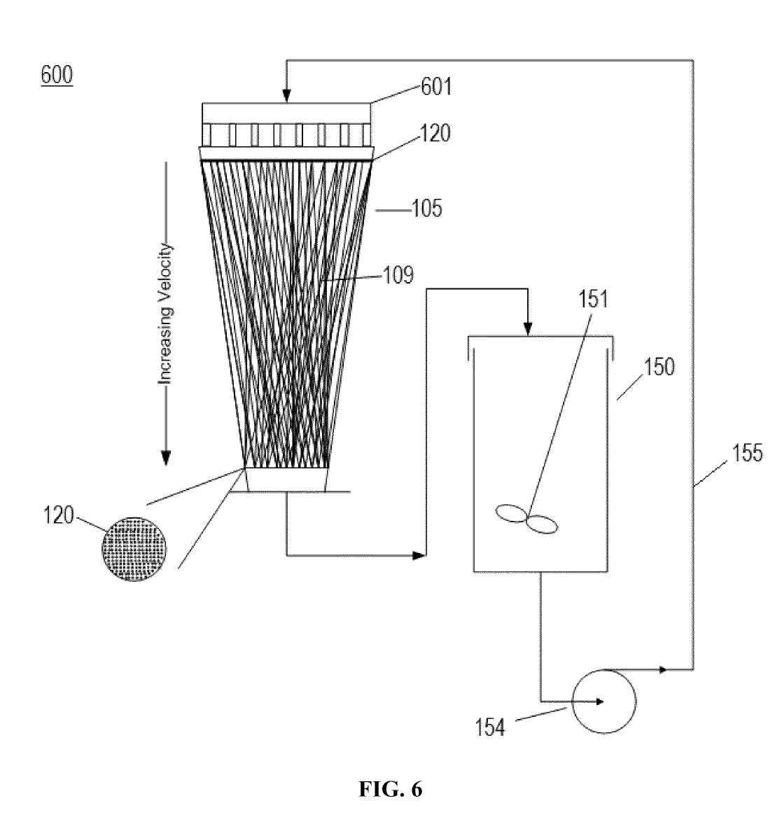

As illustrated in a further exemplary embodiment of the present invention as shown in FIG. 6, the fiber based milling device 600 includes a fiber assembly 109 disposed within a chamber 105. The fiber assembly includes one or more fibers that are fixed to a perforated plate 120 located at one or more ends of the chamber. In a preferred embodiment, a perforated plate 120 is located at both ends of the chamber. By so doing, the fibers are at least fixed in the axial direction of the chamber.

The chamber may be configured so that a diameter of the inlet is greater than the diameter of the outlet. In an exemplary embodiment, the chamber is cone or funnel shaped. This configuration induces increased velocity between the inlet and the outlet of the milling device.

In a more preferred embodiment. the fiber based milling device includes a manifold 601. the manifold preferably may be disposed above the inlet of the chamber 105. The arrangement helps regulate the flow of a fluid dispersion entering the device.

The fiber based milling device may also connected to a recirculation system including a fluid medium vessel 150. The vessel 150 may include an agitator 151. The dispersion may be pumped from the vessel 150 via a pump 154 to the inlet of the milling device. The recirculation system may include one or more tubes or pipes 155 to facilitate recirculation. Recirculation of the liquid dispersion through the milling chamber continues until a desired particle size is obtained.

The method according to an exemplary embodiment of the invention will now be explained with respect to FIG. 9. In S1, a quantity of particles for milling are obtained. The particles to be milled are then fed into a fiber based fiber based milling device including a milling chamber in S2. S3 describes a step of contacting the particles to be milled with a fiber assembly disposed in the milling chamber. As mentioned above, the fiber assembly has a preferred geometry. The preferred particle contact with the fiber assembly is capable of reducing the size of the particles. In S4, it is determined, either manually or electronically, whether the particles have achieved their particle size. Electronic determination may be carried out using a sensing device in communication with a controller.

If the particles have obtained their particle size, the particles subsequently are removed from the milling chamber in S7. If, on the other hand, the particles have not achieved their particle size after the contacting step, the particles are removed in S5 from the milling chamber and reintroduced in S6 to an inlet of the fiber based milling device for further milling. The process of re-circulating particles continues until the particle size is obtained. The particles are then recovered and removed from the fiber based fiber based milling device in S7.

The embodiments will be further explained in detail with respect to the following examples. The following examples are not limiting. The examples were conducted on a bench scale in a laboratory. It is submitted that the experiments set forth in the examples may be scaled up for commercial use.

### Example 1

A cowles type disperser blade on a Premiere “Laboratory Dispersator” Model 2000 high speed disperser is replaced with an Indco MP153A laboratory impeller. A fiber laced rubber mat measuring 3 inches wide by 2.5 inches wide high is wrapped around the circumference of the ¾ inch diameter rotating shaft and affixed with standard plastic zipper type interlock ties. The fibers interlaced to the rubber mat are Vectran HT Fiber 2.5 denier filament yarn. The fibers are interlaced into the mat to maximize the density of the fiber arrangement. The fibers are woven in a loop pattern such that the loops reach within 1/16 of an inch of the pipe mixing chamber.

The disperser shaft with fibers attached thereto is encapsulated in a cylindrical pipe arrangement surrounded by a 3 inch tall section of 304 stainless steel wire 0140 mesh (30 mesh per linear inch) cloth. The bottom of the mesh cylinder is supported by a thin stainless steel ring cut from a length of 1.5 inch 304 stainless steel pipe. The mesh is secured to the thin ring with a stainless steel hose clamp.

A primary construction feature of the basket configuration is a custom fabricated stainless steel plate affixed to the mixer head. Onto this plate is welded a 10 in. length of 1.5 in. 304 stainless steel pipe. About one half inch above the mesh basket, the pipe preferably is cut with three ¾ in. wide by 3 in. tall slots which provide a path for fluid recirculation. The upper end of the mesh screen cylinder is secured to an outer wall of the pipe with a stainless steel hose clamp.

In operation, the mechanism is lowered into a standard stainless steel laboratory vat measuring 4.5 in. D×6 in. H. A pigment, water and surfactant are mixed prior to milling with a Cowles® blade mixer for 40 minutes at 3000 RPM. The Premiere disperser is adjusted to 3,000 RPM with a Staco Energy Products 120V Variable Autotransformer. The final product is recovered from the device.

### Example 2

The Premiere disperser shaft is fitted with a custom made 316 stainless steel shaft collar measuring 3.5 in. high and 1⅝ in. in diameter. Preferably, the shaft collar is cut in two equal halves in the direction of the axis of the disperser shaft. The collar can be rejoined along its length by a vertical series of custom tapped and beveled points to accommodate seven 1¼ in. machine screws on both sides.

Inside the halved shaft collars is placed a high density of the Vectran fibers described above. The fibers are cut to a length of 2⅛ in. This will place the fiber end within 1/16 in. of the milling chamber wall. The fibers are held in place with a small amount of temporary adhesive. For example, two side adhesive transparent tape can be used. The collar halves are re-joined such that the collar bottom aligns with the bottom of the ¾ in. disperser shaft.

The above mentioned components are lowered into a standard plastic laboratory 500 milliliter graduated cylinder measuring 2 in. in diameter and cut to 10 in. in height. A pigment, water and surfactant are mixed prior to milling with a Cowles® blade mixer for 40 minutes at 3000 RPM. The Premiere disperser is adjusted to 3000 RPM with a Staco Energy Products 120V Variable Autotransformer. The final product is recovered from the device.

### Example 3

The Premiere “Laboratory Disperator” Model 2000 ¾ in. disperser shaft is adapted with circular cuts of 304 stainless steel perforated plate. The plate is manufactured by the McNichols Company of Tampa, Fla. and is commercially available in 18 gauge thickness with 1/16 in. diameter perforations. The plates are spaced ⅛ in. apart. This plate is custom cut into two 1⅜ in. diameter circles. Vectran HT 2.5 denier filament yarn fibers as supplied by Engineered Fibers Technology of Shelton, Conn. are woven between the plates such that the distance between the plates is 2¼ in. The perforated plate is fitted to the disperser shaft and secured with standard snap rings below the top plate and above the bottom plate such that the vertical fibers are immobilized relative to the vertical length of the disperser shaft. The fiber/plate arrangement is situated such that the bottom perforated plate aligns with the bottom of the disperser shaft.

A primary construction feature of the pipe configuration is a custom fabricated stainless steel plate affixed to the mixer head. The plate is welded to a 10 in. length of 1.5 in. 304 stainless steel pipe. One half inch above the mesh basket, the pipe is cut with three ¾ in wide by 3 in tall slots (two slots are shown) which provides a path for fluid recirculation induced by a 1 in. impeller having three blades.

The disperser shaft with the vertical fiber/plate construction attached is encapsulated in a cylindrical arrangement by a 3 in. tall section of 304 stainless steel wire 0140 mesh (30 mesh per linear inch) cloth. The bottom of the mesh cylinder is supported by a thin stainless steel ring cut from a length of 1.5 in. 304 stainless steel pipe. The mesh is secured to the thin ring with a stainless steel hose clamp that compresses a bend in the mesh against the steel ring and the steel pipe housing.

In operation, the mechanism is lowered into a standard stainless steel laboratory chamber measuring 4.5 in. D×6 in. H. A pigment water and surfactant are mixed prior to milling with a Cowles® blade mixer for 40 minutes at 3000 RPM. The Premiere disperser is adjusted to 3000 RPM with a Staco Energy Products 120V Variable Autotransformer (not shown). The final product is recovered from the device.

### Example 4

The standard agitator on the drive shaft of an Eiger brand MKII Mini 250 horizontal bead mill is removed and replaced with a custom fabricated spiral brush as manufactured by Spiral Brushes, Inc. of Stow, Ohio. The spiral brush consists of a central ⅞ in. ID by 1⅜ in. OD shaft sleeve mount with a standard 3/16 in.× 3/32 in. keyway. The shaft sleeve mount is surrounded by and attached to a solid metallic coil with a diameter of ⅜ in. Slightly crimped fibers constructed of 0.006 in. diameter 304 stainless steel have been securely embedded in the ⅜ in. metallic coil and the coil is wound in a spiral fashion around the shaft sleeve forming a final overall brush diameter of 3⅛ in. and overall length of 2¾ in. The fibers form a very dense continuous fiber mat containing approximately 55 individual fibers per square centimeter. The specified overall diameter of the brush is chosen to yield a very small gap between the brush and mill chamber no larger than 1/32 in. The brush is securely mounted to the shaft with the standard agitator end cap and screw.

In operation, the liquid dispersion is introduced to the product inlet funnel. The rational speed of the mill is set to 4500 RPM. Fluid is propelled to the chamber by the standard feed screw and passes into contact with the fibers after passage through a gap formed between the pump impeller and the feed ring. The pumping rate is variable with respect to the rotational speed of the shaft. With the product outlet closed, the milled fluid recirculates via the product recirculation pipe to the product inlet funnel. At all times during the process, the mill cooling jacket is supplied with an ethylene glycol/water mixture set to maintain a product temperature of 40° C. The product is sampled at 30 minutes and the milling and recirculation process continues for two hours. At this time the mill is de-energized and the product is recovered through the product outlet port.

### Example 5

In this example, a Premiere “Laboratory Dispersator” Model 2000 high speed disperser is fitted with a specially machined ¾ diameter by 11 long rotating shaft. The shaft is modified by preferably machining six evenly spaced ⅜ in. holes with 5/16 in. counter opposing set screws. A 2.2 gram bundle of Vectran HT™ fiber supplied by Engineered Fibers Technology of Shelton, Conn. is cut as strands to a length of 2½ in. and is secured at the center of the bundle in each of the six mounting holes by the set screws. The Vectran HT™ fiber is supplied as spooled strands of filament yarn. Each strand contains approximately 50 individual continuous fibers of 2.5 denier measured optically at about 15 micron diameter and a published tensile strength of 2,850 to 3,340 MPa.

The shaft with fibers attached thereto is encapsulated in a cylindrical arrangement constructed from an 11 in. section of 2 in. ID 316 stainless steel pipe. There is a 2½ in. fiber bundle length set to provide a ¼ in. of excess length at the pipe wall to enhance high speed shear effects. The top of the pipe enclosure is attached to the mixer head with a thin circular plate welded to the pipe and drilled with a bolt pattern matching that of the mixer motor such that the entire assembly is securely bolted to the mixer body in conjunction with the mixer motor. The pipe enclosure contains two diametrically opposed ¼ in. diameter by ½ in. long screw inserts threaded into the pipe at the approximate mid-point level of each fiber bundle. The screws provide interference to the rotating fiber bundles to prevent any undesirable matting of the fiber bundle.

### Example 6

In this example, a Hockmeyer HCPN Micro Mill of immersion style construction is charged with a manually cut polymeric fiber. The fiber is a commonly available blend of nylon polymers sold as fishing line with a tensile strength of 0.103 Newtons per square millimeter. The fiber is cut manually into small pieces with an average length of 2.9 mm and an average diameter of 0.43 mm.

The performance of the fiber mill was compared with a conventional mill device. Specifically, one kilogram of a pre-grind material is introduced to the HCPN mill chamber and the milling head containing the cut fibers is lowered into the pre-grind mixture with the impeller 2 inches from the bottom of the milling chamber. The mill speed is adjusted to 5,000 RPM and allowed to run for a period of two hours. The final product is recovered from the device.

It will be apparent to those skilled in the art that various modifications and variations can be made in the present invention without departing from the spirit and scope of the invention. Thus, it is intended that the present invention cover the modifications and variations of this invention provided they come within the scope of the appended claims and their equivalents.

What is claimed is:

1. A method of milling particles comprising the steps of:
obtaining a quantity of particles to be milled;
feeding said particles into a milling chamber;
contacting said particles with a fiber assembly disposed in said chamber to reduce the size of said particles to produce milled particles; and
removing said milled particles from said milling chamber.

2. The method according to claim 1, further comprising:
removing said particles after said contacting step; and
reintroducing said particles to said milling chamber.

3. The method according to claim 1, wherein said contacting step comprises rotating said fiber assembly in said milling chamber.

4. The method according to claim 1, wherein said contacting step comprises impacting said fiber assembly with a pressurized fluid containing said particles.

5. A fiber based milling device comprising:
a chamber including an inlet and an outlet;
a shaft disposed within said chamber;
at least one fiber assembly disposed and secured to said shaft by a securing mechanism within said chamber; and
a motor connected with said shaft to provide rotation.

6. The fiber based milling device according to claim 5, wherein said securing mechanism comprises a substrate disposed around at least a first portion of said shaft.

7. The fiber based milling device according to claim 5, wherein said securing mechanism comprises a shaft collar disposed around at least a first portion of said shaft.

8. The fiber based milling device according to claim 5, wherein said securing mechanism comprises a perforated plate disposed around said rotating shaft.

9. The fiber based milling device according to claim 5, wherein said securing mechanism comprises an adhesive.

10. The fiber based milling device according to claim 5, wherein said securing mechanism comprises a coil disposed around said shaft.

11. The fiber based milling device according to claim 5, wherein said securing mechanism comprises at least one screw for respectively securing said fiber assembly to one or more holes formed in said rotating shaft.

12. The fiber based milling device according to claim 5, wherein said fiber assembly comprises a brush arrangement.

13. The fiber based milling device according to claim 5, further comprising at least two fiber assemblies separated from each other by a predetermined distance.

14. The fiber based milling device according to claim 5, wherein said fiber assembly substantially extends to an inner wall of said chamber.

15. The fiber based milling device according to claim 5, further comprising:
a recirculation mechanism.

16. A fiber based milling device comprising:
a chamber including an inlet and an outlet;
at least one fiber assembly disposed in said chamber;
at least one securing mechanism disposed in said chamber; and
at least one pumping mechanism.

17. The fiber based milling device according to claim 16, wherein said securing mechanism comprises a perforated plate.

18. The fiber based milling device according to claim 16, wherein said securing mechanism is arranged at said inlet or said outlet.

19. The fiber based milling according to claim 16, wherein the diameter of said inlet is greater than the diameter of said outlet.

20. The fiber based milling device according to claim 16, further comprising:
a manifold disposed around said inlet.

21. A fiber based milling device comprising:
a chamber having an inlet and an outlet;
a fiber assembly including one or more fibers for contacting particles to be milled;
a mechanism for milling said particles such that one or both of said fiber assembly and said particles move relative to one another; and
a motor for delivering power to said mechanism.

22. The fiber based milling device according to claim 21, wherein said one or more fibers are freely dispersed in said chamber.

23. The fiber based milling device according to claim 21, wherein said mechanism comprises at least one of a shaft and a pumping device.

24. The use of said fiber based milling device in claim 5 to mill particles.

25. The use of said fiber based milling device in claim 16 to mill particles.

26. The use of said fiber based milling device in claim 21 to mill particles.
